(19) United States
(12) Patent Application Publication
(10) Pub. No.: US 2015/0302596 A1
(43) Pub. Date: Oct. 22, 2015

(54) IMAGE PROCESSING METHOD AND AN IMAGE PROCESSING APPARATUS

(71) Applicant: YAMAGUCHI UNIVERSITY, Yamaguchi (JP)

(72) Inventors: Yoshiki Mizukami, Ube-shi (JP); Koichi Okada, Yamaguchi-shi (JP); Atsushi Nomura, Yamaguchi-shi (JP); Shinya Nakanishi, Ube-shi (JP); Katsumi Tadamura, Ube-shi (JP)

(73) Assignee: Yoshiki Mizukami, Ube-shi, Yamaguchi (JP)

(21) Appl. No.: 14/441,722

(22) PCT Filed: Nov. 8, 2013
(86) PCT No.: PCT/JP2013/080340

§ 371 Date: May 8, 2015

(30) Foreign Application Priority Data
Nov. 9, 2012 (JP) 2012-247692

(51) Int. Cl. G06T 7/00

(52) U.S. Cl. CPC G06T 7/0075; G06T 2207/10012

(57) ABSTRACT

A sub-pixel disparity cost volume which contains initial cost values of dissimilarity calculated between the pixel values on a standard image of a plurality of parallax images and the interpolated sub-pixel values on the counterpart image or images other than said standard image is prepared for a plurality of parallax images of objects in a three-dimensional structure composed of horizontal, vertical and disparity axes. Noise signals on the calculated cost values in the sub-pixel disparity cost volume are eliminated by using an edge-preserving filter which allocates bigger weights between two cost values whose pixel coordinates have similar pixel values on the standard image, for preserving edges or boundaries of the objects. A sub-pixel disparity is selected, which gives the minimum cost value in the specific disparity range around a previously-given initial pixel-wise or sub-pixel disparity at each pixel coordinate on the standard image. Thus the distance to the objects is estimated from the computed disparity. Precise disparity can be computed by preparing a sub-pixel disparity cost volume and then computing the sub-pixel resolution disparity. Further, the necessary processing time can be reduced by parallel computation manner.

### FIELD OF THE INVENTION

This invention is related with an image processing method and an image processing apparatus for estimating the distance between a viewpoint and objects based on a plurality of parallax images that contain disparities.

### BACKGROUND OF THE INVENTION

Various conventional image processing methods have been employed for estimating the distance between a viewpoint and objects based on several parallax images that were taken from different viewpoints. Computing the distance between a viewpoint and objects is useful and essential for distance measurement tasks in controlling robots and transportation vehicles and estimating the location of items in manufacturing scenes and it therefore has been employed in various forms of applications.

FIGS. 1 and 2 illustrate the disparity obtained from a pair of parallax images that were taken from different viewpoints. FIG. 1 is a perspective view showing a scene including a pillar (a), a rectangular parallelepiped (b), a cone (c) and two cameras A1 and A2 disposed side by side, which capture these objects. FIGS. 2(a) and (b) show left and right camera images, respectively. The object closer to the camera is captured at a position shifted to left-side in the right camera image (b) compared with the original position in the left camera image (a). Generally speaking, the closer object has bigger displacement (disparity) than the far object, and therefore it is possible to estimate the distance to the object by computing disparity from two parallax images.

The following documents describe several image processing methods for estimating the distance between a viewpoint and objects by computing disparity based on a plurality of parallax images. Japanese Published Patent Application No. 2003-16427 (Patent document 1) describes a disparity computation method which updates disparity by sub-pixel correspondence around the initial pixel-wise correspondence obtained between two stereo images. Japanese Published Patent Application No. 2003-150939 (Patent document 2) describes a procedure for acquiring distance images with sub-pixel-disparity resolution, in which the sub-pixel values on the image are interpolated and then stereo matching was applied to the image pair for calculating the displacement of pixel blocks.

Japanese Published Patent Application No. 2005-250994 (Patent document 3) describes the accuracy improvement of stereo matching, in which virtual pixels are interpolated and inserted between pixels on a pair of stereo images and the pixels are made to correspond between the two resolution-increased images, in a stereo image processing for performing stereo matching by use of a pair of images having correlation each other. Japanese Published Patent Application No. 2011-185720 (Patent document 4) describes a distance measurement device, in which the distance to objects is estimated from the average of normalized disparities if the disparities, which have been computed after interpolating sub-pixel values on the counterpart image, are similar.

C. Rhemann et al., Fast cost-volume filtering for visual correspondence and beyond, CVPR 2011, pp. 3017-3023 (Non-patent document 1) describes a pixel-wise disparity computation method which produces pixel-wise disparity cost volume, applies a filtering procedure to the cost volume, and finds the disparity which gives the minimum cost value at each pixel coordinate.

### SUMMARY OF THE INVENTION

In order to estimate the distance to objects using a plurality of parallax images, the disparity is computed from these images and then the distance to the objects is estimated from the disparity in many conventional methods. Since these parallax images are represented as digital images, the precise distance to the objects cannot be obtained only by computing pixel-wise disparity from the pixel values on the images.

Therefore, unlike the pixel-wise disparity computation method described in Non-Patent Document 1, Patent Document 1 and 2 discuss the acquirement of more precise sub-pixel disparity from obtained digital parallax images. These approaches calculate similarity (or dis-similarity) in a rectangular region by block matching techniques without considering the edges (boundaries, contours or outlines) of objects when the noise signals in matching two stereo images are eliminated. Consequently, the accuracy of the computed disparity was insufficient because the edges of the objects were not considered.

On the other hand, Non-Patent Document 1 succeeded in eliminating the noise signals with considering the edges (boundaries, contours or outlines) by applying Guided Filter to the previously-prepared cost volume obtained from a pair of images in a highly-parallel computation manner, but this approach could not provide precise disparity resolution due to the limitation of pixel-wise disparity computation.

This invention aims to provide very precise disparity with a high resolution from a plurality of images in a fast parallel computation manner and to contribute to fast distance estimation applications.

The present invention aims to solve the above-mentioned problems.

The image processing method for estimating the distance to objects from a plurality of parallax images according to the present invention comprises:

preparing a sub-pixel disparity cost volume which contains initial cost values of dissimilarity calculated between the pixel values on a standard image of said plurality of parallax images and the interpolated sub-pixel values on the counterpart image or images other than said standard image in a three-dimensional structure composed of horizontal, vertical and disparity axes,

eliminating noise signals on said initial cost values in the sub-pixel disparity cost volume while preserving edges or boundaries of the objects by using an edge-preserving filter which allocates bigger weights between two cost values whose pixel coordinates have similar pixel values on the standard image, and

selecting a sub-pixel disparity which gives the minimum cost value in the specific disparity range around a previously-given initial pixel-wise or sub-pixel disparity at each pixel coordinate on the standard image to estimate the distance to the objects from the computed disparity.

The parallax images may be captured by a plurality of image capturing means.

The image processing apparatus for estimating the distance to objects from a plurality of parallax images comprises:

a cost volume preparing portion for preparing a sub-pixel disparity cost volume which contains initial cost values of dissimilarity calculated between the pixel values on a standard image of said plurality of parallax images and the interpolated sub-pixel values on the counterpart image or images other than said standard image in a three-dimensional structure composed of horizontal, vertical and disparity axes,

a filtering portion for eliminating noise signals on the initial cost values in the sub-pixel disparity cost volume while preserving edges or boundaries of objects by using an edge-preserving filter which allocates bigger weights between two cost values whose pixel coordinates have similar pixel values on the standard image,

a disparity selecting portion for selecting a sub-pixel disparity which gives the minimum cost value in the specific disparity range around a previously-given initial pixel-wise or sub-pixel disparity at each pixel coordinate on the standard image, and

a distance estimating portion for estimating the distance to the objects from the computed disparity.

The image processing apparatus may further comprise a plurality of image capturing means for capturing a plurality of parallax images of the objects, said plurality of parallax images being captured by said image capturing means.

The image processing method and image processing apparatus according to the present invention aim to estimate the distance in which a sub-pixel disparity cost volume is prepared based on a plurality of parallax images obtained by capturing objects, the noise signals on the cost values are eliminated while preserving the edges or boundaries of the objects, the disparity is computed, and finally the distance to the objects is estimated from the disparity.

Although disparity computation by using a cost volume was so far conducted only in the pixel-wise accuracy, the present invention enables the precise disparity (and distance to the objects) to be computed by preparing a sub-pixel disparity cost volume and then computing the sub-pixel resolution disparity. In addition, the necessary processing time can be reduced by a parallel computation manner.

### BRIEF DESCRIPTION OF DRAWINGS

FIG. 1 is a perspective view showing a scene including objects to be captured and two cameras located side by side.

FIGS. 2(a) and (b) show left and right camera images, respectively, in which the objects shown in FIG. 1 are captured by two stereo cameras.

FIG. 3 is an illustration for explaining the calculation of the cost values in the cost volume.

FIG. 4 is an illustration for exemplifying the cost volume.

FIG. 5 is an illustration for exemplifying sub-pixel disparity selection in the sub-pixel disparity cost volume.

FIG. 6 is a flowchart of the image processing method for estimating the distance to objects according to the present invention.

FIG. 7 illustrates the configuration of the image processing apparatus for estimating the distance to objects according to the present invention.

### DETAILED DESCRIPTION OF PREFERRED EMBODIMENTS

In the invented image processing method and image processing apparatus, the distance to the objects is estimated in which a sub-pixel disparity cost volume is prepared based on a plurality of parallax images taken by capturing the objects, the noise signals on the cost values are eliminated while considering the edges or boundaries of objects, and then the sub-pixel resolution disparity is computed.

Here, and similarly in other places, “distance” is denoted as generalized expression. When individual distance to a specific object is to be considered, “distance” is to be taken as “distances to respective objects”, since there are a plurality of objects in an image.

After the disparity on the images is computed, the distance or depth information will be restored according to the properties of the cameras and their positions. The sub-pixel disparity cost volume will be explained at first.

The sub-pixel disparity cost volume was obtained by understanding the idea of the pixel-wise disparity cost volume and extending it to the sub-pixel disparity resolution. In order to compute the disparity and estimate the distance to objects from a plurality of parallax digital images, the invented method prepares a sub-pixel disparity cost volume which contains cost values (dis-similarity or error) calculated between the pixel values on a standard image and the interpolated sub-pixel values on the counterpart image in a three dimensional structure composed of horizontal, vertical and disparity axes. Then the invented method eliminates the noise signals on the cost values in the sub-pixel disparity cost volume and then selects a sub-pixel disparity which gives the minimum cost value. Please notice that the selection of the pixel-wise disparity in a pixel-wise disparity cost volume is described in Non-Patent Document 1.

(a) Preparing a Sub-Pixel Disparity Cost Volume

Cost volume is an aggregation of cost values at coordinates (x, y, d) of horizontal, vertical, and disparity axes in which the cost values are calculated as a correspondence error between the pixel values on a standard image and the interpolated sub-pixel values on the counterpart image, and the cost value indicates the reliability or possibility of the disparity of d at the coordinate (x, y) on the standard image.

Now let us assume that a stereo pair of images was taken by a pair of cameras arranged side by side in horizontal parallel, and that left and right images are called as standard and counterpart images, respectively. Nevertheless to say, the same description can be applicable and understandable for the cases where they are arranged in vertically or diagonally parallel.

Pixel-wise disparity cost volume is an aggregation of cost values distributed at coordinates (x, y, d) of horizontal, vertical, and disparity axes in which the cost value is calculated as a correspondence error between the pixel values on a standard image and the pixel values on the counterpart image. When the pixel-wise disparity is assumed to range from 0 to N−1, the pixel-wise disparity cost volume has N layers in the disparity direction. This invented method deals with sub-pixel disparity and therefore the cost volume should have sub-pixel disparity resolution. The sub-pixel disparity cost volume has (N−1)*SPDR+1 layers where SPDR refers to the degree of sub-pixel disparity resolution. For instance, SPDR=1 indicates pixel-wise disparity resolution which does not insert any sub-pixel disparity layers between neighboring pixel-wise disparity layers, and SPDR=2 indicates sub-pixel disparity resolution which inserts a single sub-pixel disparity layer between neighboring pixel-wise disparity layers and gives 0.5-pixel resolution.

Cost value, C_(x,y,d), in the pixel-wise disparity cost volume is calculated based on the pixel value, I_(x,y), at the coordinate (x,y) on the standard image and the pixel value, I′_(x-d, y), at the d-offset coordinate (x-d, y) on the counterpart image, as described in the following equation,

[EQ-1]

C_{x,y,d}=(1−α)·min [∥I′_{x-d,y}−I_{x,y}∥, τ₁]+α·min [∥gradₓI′_{x-d,y}−gradₓ I_{x,y}∥, τ₂] (1)

where the first term in the right side indicates the absolute error between the pixel values at (x,y) on the standard image and (x-d,y) on the counterpart image, and the second term indicates the absolute error between the horizontal first deviations between these pixel coordinates, and grad_(x) is an operator giving the horizontal first deviation, (alpha) is a parameter balancing between pixel and deviation errors, (tau_{—}1) and (tau_{—}2) are upper limit parameters, and min is a function giving the smallest argument value.

When I and I′ are color images, the error calculated at each color channel can be summed up or the above equation can be applied to gray images obtained by converting the color images. Cost value, C_(x,y,d), in the cost volume indicates the amount of difference between the pixel value at the coordinate of (x,y) on a standard image I and the pixel value at the d-offset coordinate on the counterpart image I′. The various kinds of norm can be employed in Equation (1), for example, a power operator and an absolute operator. The vertical first deviation can be also considerable as a natural extension for this equation. Instead of cost, distance or dis-similarity, similarity can be utilized in preparing the cost volume, but there will be several points to be modified such as finally selecting a sub-pixel disparity which has the biggest similarity instead of a sub-pixel disparity which has the smallest dis-similarity.

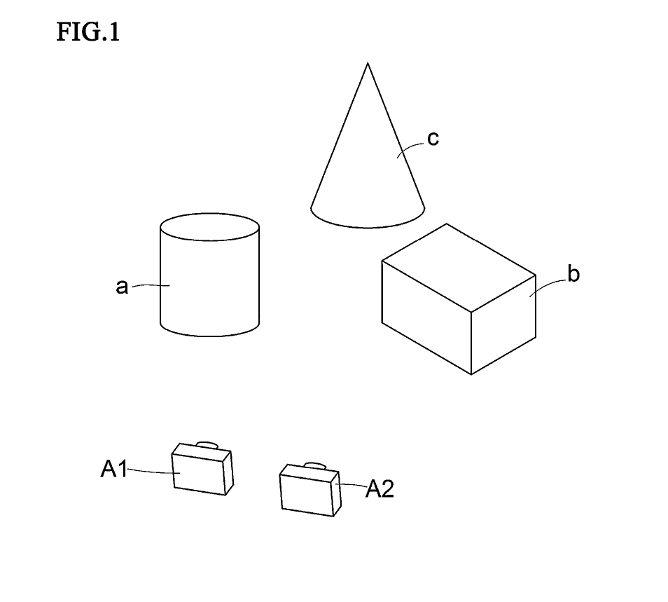

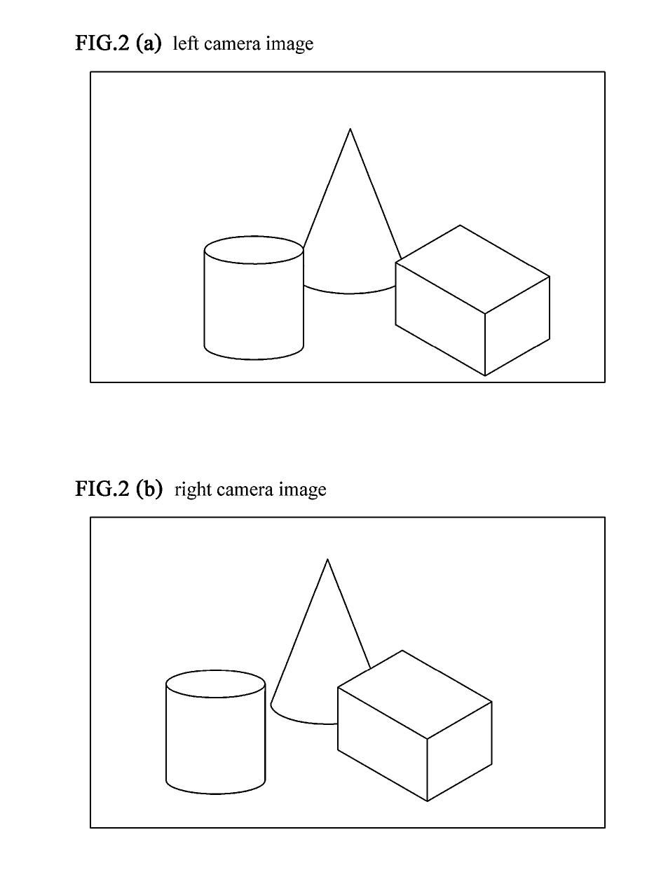

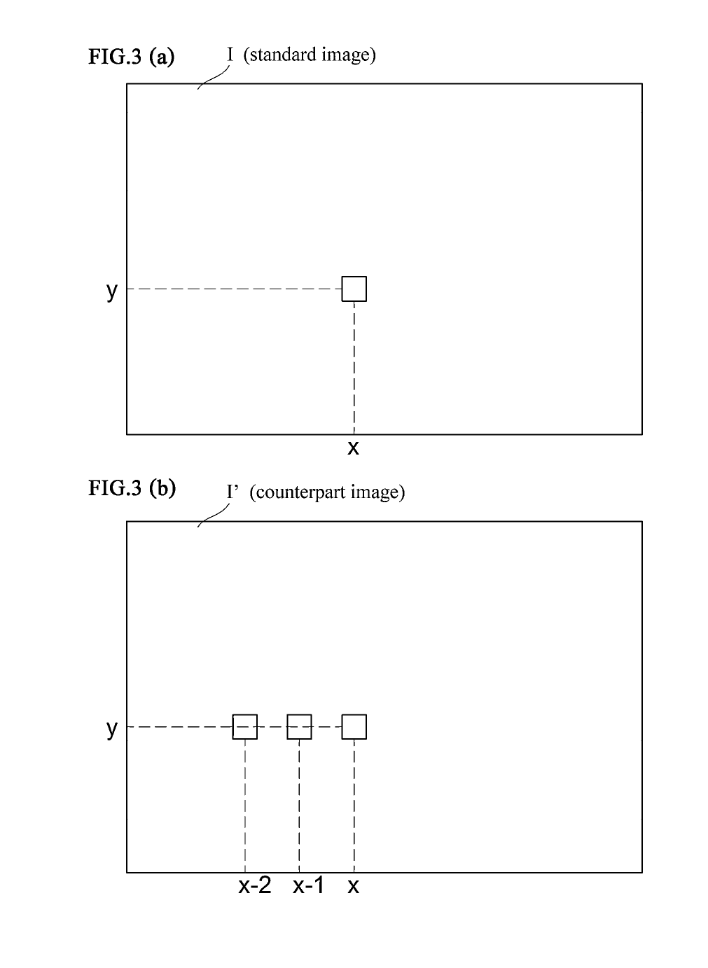

FIG. 3 illustrates the procedure for calculating cost values in the cost volume, where left camera image I and right camera image I′ are referred to as a standard and the counterpart image, respectively, and these images are taken by two horizontally-arranged cameras, A1 and A2, as shown in FIG. 1. When these cameras are horizontally arranged, there will be the horizontal disparity in x direction between the two images. In calculating the cost values, for example, firstly the pixel value at (x,y) on the counterpart image will be compared with the pixel value at (x,y) on the standard image. Secondly the pixel value at (x−1,y) will be compared with it and thirdly the pixel value at (x−2,y) will be compared in the same manner. The coordinate units of x and y are defined by the distance between the centers of neighboring pixels.

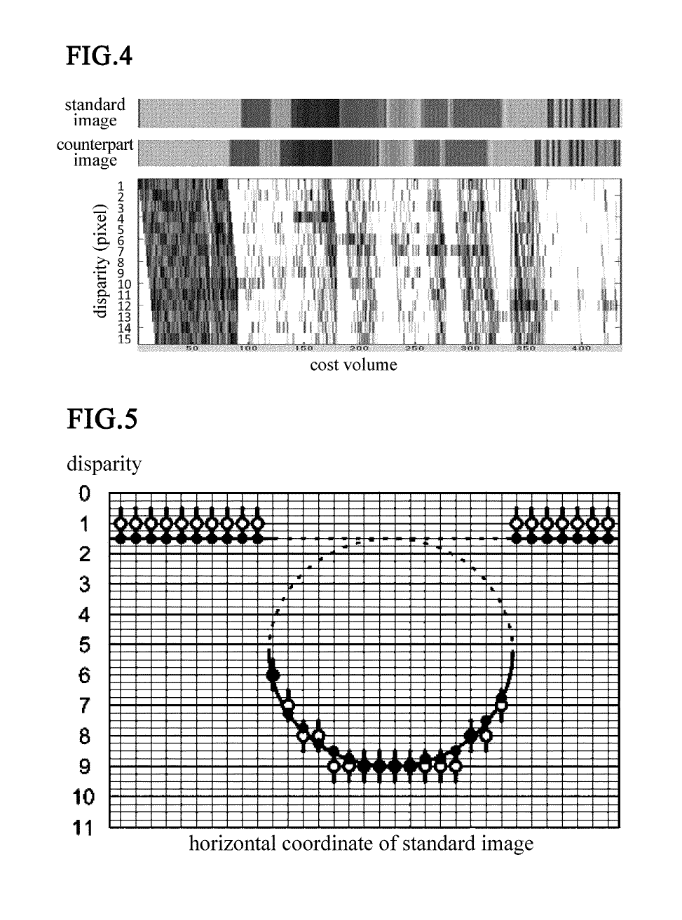

The cost volume is an aggregation of cost values calculated at (x, y, d) in a three dimensional structure composed of horizontal, vertical and disparity axes. FIG. 4 exemplifies a cross section along x-d surface of the cost volume calculated at a y-coordinate of the standard image which contains disparity.

C_(x,y,d) is an initial cost value calculated by applying Equation 1 to given images and C′_(x,y,d) is a filtered cost value specified by Equation (2) of the initial cost value.

$$\begin{matrix}[ EQ \text{-} 2 ] & \\ {C}_{x , y , d}^{′} = {\sum }_{{x}^{′} , {y}^{′}}^{ } {W}_{x , y , {x}^{′} , {y}^{′}} ( I ) {C}_{{x}^{′} , {y}^{′} , d} & ( 2 )\end{matrix}$$

This filtering weight value, W_(x,y,x′,y′), is controlled by the pixel value similarities and the pixel distances between the pixel (x,y) and one of the neighboring pixels (x′,y′) in a local window, on the standard images.

When Guided filter described in Non-Patent Document 1 is employed as the weight function in Equation 2 for considering the object edges, the weight value between (x,y) and (x′,y′), W_(x,y,x′,y′), is calculated based on the statistical analogy according to the averages and variances in a plurality of rectangular regions on the image, as expressed by the following Equation (3).

$$\begin{matrix}[ EQ \text{-} 3 ] & \\ {W}_{x , y , {x}^{′} , {y}^{′}} = \frac{1}{{\vert ω \vert}^{2}} {{\sum }_{k \text{:} ( ( x , y ) , ( {x}^{′} , {y}^{′} ) ) ∈ {ω}_{k}} ( 1 + \frac{( {I}_{x , y} - {μ}_{k} ) ( {I}_{{x}^{′} , {y}^{′}} - {μ}_{k} )}{{σ}_{k}^{2} + ɛ}}_{ }^{ } ) & ( 3 )\end{matrix}$$

Here (mu)_k and (sigma)_k̂2 refer to average and variance of pixel values in a r̂2-sized rectangular window, (omega_k), centered at k=(x_k,y_k).

When the coordinates of (x,y) and (x′,y′) are on the same object, their pixel values tend to be similar and then the pixel value similarity will increase W_(x,y,x′,y′). On the other hand, when the coordinates of (x,y) and (x′,y′) are on different objects, their pixel values do not tend to be similar and then the pixel value similarity will decrease W_(x,y,x′,y′). When the coordinates of (x,y) and (x′,y′) are near or close to each other, the pixel distance will increase W_(x,y,x′,y′). In order to finally decide the disparity, the initial cost volume C_(x,y,d) is given by Equation (1) and then the cost volume is filtered to produce the filtered cost volume C′_(x,y,d), and consequently the most possible disparity is selected at the coordinate (x,y) in the filtered cost volume C′_(x,y,d).

Although Equation (1) is related with pixel-wise disparity cost volume, this invention discusses a sub-pixel disparity cost volume for estimating more precise distance to the objects. Digital images consist of pixels and therefore the pixel values are given only at the pixel coordinates. In this invention, the values at sub-pixel coordinates (sub-pixel values) between pixels are calculated by an interpolation method and a sub-pixel disparity cost volume is prepared based on the interpolated sub-pixel values.

SPDR (sub-pixel disparity resolution) is introduced for indicating the disparity resolution in the cost volume. SPDR=1 means that there is no sub-pixel disparity layer between pixel-wise disparity layers, and SPDR=2 means that there is a single sub-pixel disparity layer between them. The cost values in the sub-pixel disparity cost volume are given by the following Equation (4) which is introduced by extending Equation (1).

[EQ-4]

C_{x,y,d}=(1−α)·min [∥I′_{x-d/SPDR,y}−I_{x,y}∥, τ₁]+α·min [∥gradₓI′_{x-d/SPDR,y}−gradₓ I_{x,y}∥, τ₂] (4)

where I_(x,y) and I′_(x,y) are pixel values at the coordinate (x,y) on the standard and the counterpart image, respectively, and the integer parameter, d, is the disparity layer index whose range is [0: max_pixel_wise_disparity*SPDR], that is, C_(x,y,d) is a cost value at the coordinate of (x,y) with the sub-pixel disparity of d/SPDR, and grad_(x) is an operator giving the horizontal first deviation, (alpha) is a parameter balancing between pixel and deviation errors, (tau_{—}1) and (tau_{—}2) are upper limit parameters, and min is a function giving the smallest argument value. The pixel value at the sub-pixel coordinate, I′_(x-d/SPDR,y), is calculated by applying an interpolation method to the pixel values at the neighboring pixel coordinates.

(b) Filtering the Sub-Pixel Disparity Cost Volume

After the initial sub-pixel disparity cost volume is prepared by Equation (4), the cost volume will be filtered by using Equation (2). If Guided filter is employed, the filtering weights will be decided by using Equation (3). The variance, (sigma)_k̂2, is increased in a rectangular window with high contrast texture, and then the weights, W_(x,y,x′,y′), tend to be constant. On the other hand, the variance is decreased in the window with low contrast texture, and then the weights tend to be sensitive to the statistical analogy between the pixel values at the coordinates of (x,y) and (x′,y′).

In other words, if there is a high-contrast edge in a low contrast window, a large value will be assigned to the weight between two pixels on the same side, and a small value will be assigned to the weight between two pixels on the different sides. Consequently, the cost volume will be smoothed according to the edge or boundary locations on the standard image. The parameter (eta) controls the effect of the variance, (sigma)_k̂2, on the weight value.

Although the filtered cost volume, C′_(x,y,d), is given from the initial cost volume C_(x,y,d) by using Equation (3), Equations (5)-(7) can implement the same calculation in a parallel computation manner.

$$\begin{matrix}[ EQ \text{-} 5 ] & \\ {C}_{x , y , d}^{′} = {\overline{a}}_{k}^{T} {I}_{x , y} + {\overline{b}}_{k} & ( 5 ) \\ {a}_{k} = {( {{\sum }^{ }}_{k} + ɛ U )}^{- 1} ( \frac{1}{\vert ω \vert} {\sum }_{( x , y ) ∈ {ω}_{k}}^{ } {I}_{x , y} {C}_{x , y , d} - {μ}_{k} {\overline{C}}_{k , x , y , d} ) & ( 6 ) \\ {b}_{k} = {\overline{C}}_{k , d} - {a}_{k}^{T} {μ}_{k} & ( 7 )\end{matrix}$$

where ¥bar(a)_k and ¥bar(b)_k are the average values of a_k and b_k in the rectangular window, (omega)_k, respectively, and ¥bar(C)_(k,d) is the average of C_(x,y,d) in the window. When I_(x,y) is a color image, a_k is a 3-dimensional vector, U is a unit matrix with size of 3*3, and ¥Sigma_k is a co-variance matrix with size of 3*3. Please note that the average and variance computation can be conducted very efficiently by using SAT (Summed Area Table) and its computation complexity is O(n).

As described above, the noise signals in the cost values is eliminated by applying a smoothing filter which has reasonable weights to the same disparity layer in the sub-pixel disparity cost volume. The weights in the edge-preserving smoothing filer are decided so that they have bigger weight values between cost values which have similar pixel values on the standard image, thus the noise signals in the cost values are eliminated while preserving the edges or boundaries of objects. Please note that above-described Guided Filter is one of the choice and other edge-preserving filters including Bilateral Filter, well known in the art, can be employed as a substitute for Guided Filter.

(c) Selecting Sub-Pixel Disparities

A sub-pixel disparity which gives the minimum cost value at each pixel coordinate on the standard image is selected in the specific disparity range around the previously-given initial disparity. The initial disparity might be calculated by using conventional pixel-wise disparity computation methods. Another idea is to adopt a pixel-wise disparity having the minimum cost through the pixel-wise layers in the sub-pixel disparity cost volume as an initial disparity.

The initial disparity is decided at the coordinate of (x,y) on the standard image in a Winner-Take-All (WTA) manner by using the following Equation (8).

$$\begin{matrix}[ EQ \text{-} 6 ] & \\ {f}_{x , y} = arg {min}_{d} {C}_{x , y , d}^{′} & ( 8 )\end{matrix}$$

Pixel-wise disparities are employed as the initial disparity for stability and reliability as described here, but roughly-correct sub-pixel disparity can be also adopted as the initial disparity. The point is that the pixel-wise or sub-pixel disparity should be given as an initial disparity in advance for finally selecting the sub-pixel disparity.

Let us explain how to select the precise sub-pixel disparity according to the initial disparity. FIG. 5 exemplifies the disparity selection in a scene where there is a round object in front of a wall. White circles indicate the initial disparities and the vertical think lines indicate the ranges for selecting the sub-pixel disparities that are represented with black dots. Our experiments clarified that the range should be between the initial disparity −0.5 pixel and the initial disparity +0.5 pixel, but wider range can be employed, for example between −1 pixel and +1 pixel. In the case shown in FIG. 5, SPDR is set to 4 and therefore three sub-pixel disparity layers are inserted between the neighboring pixel-wise disparity layers.

[Flowchart of the Image Processing for Estimating the Distance to Objects]

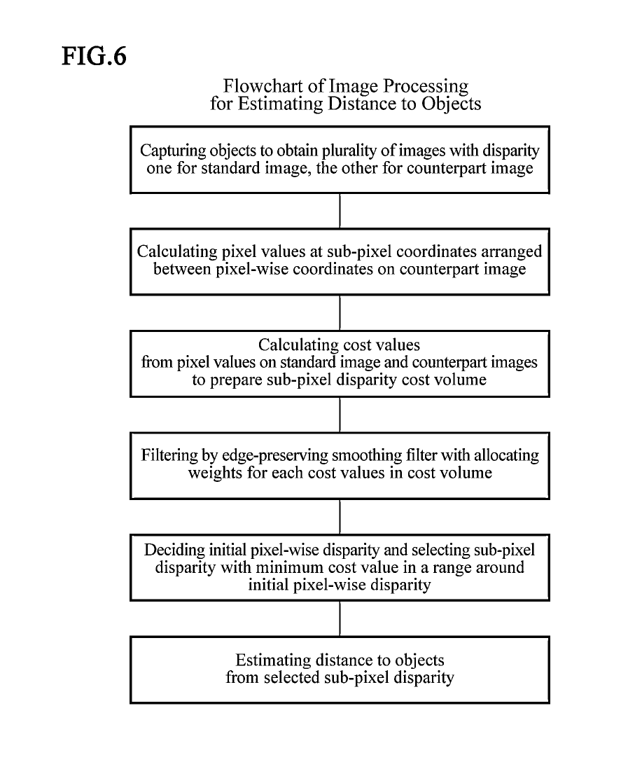

FIG. 6 is a flowchart for explaining processing steps in the image processing for estimating the distance to the objects according to this invention.

Firstly a plurality of images of objects with disparity are captured by a plurality of cameras. One of them and the others are used as a standard image and counterpart images, respectively.

Secondly an interpolation method is used to calculate the pixel values at sub-pixel coordinates which are arranged between pixel-wise coordinates on the counterpart image.

Thirdly the invented method prepares a sub-pixel disparity cost volume according to Equation (4) which contains cost values (dis-similarity or error) calculated between the pixel-wise values on a standard image and the interpolated sub-pixel values on the counterpart image in a three dimensional structure composed of horizontal, vertical and disparity axes.

Fourthly the invented method eliminates the noise signals on the calculated costs in the sub-pixel disparity cost volume while preserving edges or boundaries of objects by using an edge-preserving smoothing filter, according to Equations (5) to (7), which allocates bigger weights between two cost values whose pixel coordinates have similar pixel values (or intensities) on the standard image, thus producing a filtered sub-pixel disparity cost volume.

Fifthly the invented method decides the initial pixel-wise disparity by applying WTA to the pixel-wise disparity layers in the cost volume and selects the sub-pixel disparity with the minimum cost value in the specified range around the initial pixel-wise disparity.

Sixthly the invented method estimates the distance from the computed disparity.

The above descriptions assume that several parallax images are obtained by capturing objects using a plurality of cameras, but the same procedure or idea is applicable to the parallax images which have been already stored.

[Image Processing Apparatus for Estimating the Distance to the Objects]

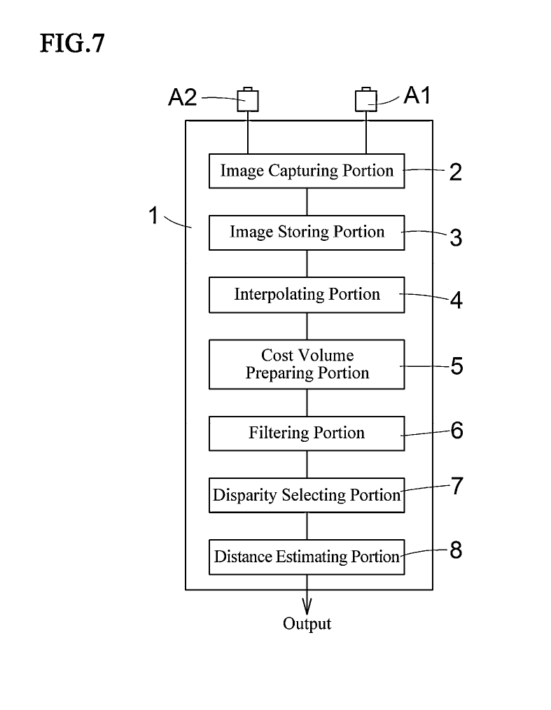

FIG. 7 indicates the configuration of an image processing apparatus according to this invention for estimating the distance to objects, where A1 and A2 are a plurality of cameras positioned in apposition to take parallax images of the objects. Nevertheless to say, three or more cameras can be utilized. Reference number 1 indicates the whole of the processing device for estimating the distance to the objects according to several captured images. Image Capturing Portion 2 captures the plurality of images taken by camera A1 and A2 and they are stored in Image Storing Portion 3. One of them and the others are used as a standard image and counterpart images, respectively. Interpolating Portion 4 calculates the pixel values by using a specified interpolation method at specified sub-pixel coordinates which are arranged between pixel-wise coordinates on the counterpart images.

Cost Volume Preparing Portion 5 prepares a sub-pixel disparity cost volume which contains initial cost values (dis-similarity or error), C_(x,y,d), calculated between the pixel values on a standard image and the interpolated sub-pixel values on the counterpart image by using Equation (4). Filtering Portion 6 calculates the—filtered cost values, C′_(x,y,d), where the initial cost volume is smoothed by using Equations (5), (6), (7) so as to preserve the edges or boundaries of objects on the standard image.

Disparity Selecting Portion 7 adopts a pixel-wise disparity having the minimum cost through the pixel-wise layers in the sub-pixel disparity cost volume as an initial disparity and then finally selects a sub-pixel disparity having the minimum cost in a specified disparity-directional range around the initial disparity. Distance Estimating Portion 8 estimates the distance to the objects from the computed disparity.

The above descriptions assume that a plurality of parallax images are obtained by capturing objects using a plurality of cameras, but the same configuration is applicable to the parallax images which have been already captured and stored.

This invention is applicable to various technology fields including survey work, assistance for driving vehicles, robot autonomous cruising, safety monitoring system, measurement and control in factory automation where image processing technologies are applied to estimate the distance to objects and detect their locations.

What is claimed is:

1. An image processing method for estimating the distance to objects from a plurality of parallax images, comprising:
preparing a sub-pixel disparity cost volume which contains initial cost values of dissimilarity calculated between the pixel values on a standard image of said plurality of parallax images and the interpolated sub-pixel values on the counterpart image or images other than said standard image in a three-dimensional structure composed of horizontal, vertical and disparity axes,
eliminating noise signals on said initial cost values in the sub-pixel disparity cost volume while preserving edges or boundaries of the objects by using an edge-preserving filter which allocates bigger weights between two cost values whose pixel coordinates have similar pixel values on the standard image, and
selecting a sub-pixel disparity which gives the minimum cost value in the specific disparity range around a previously-given initial pixel-wise or sub-pixel disparity at each pixel coordinate on the standard image to estimate the distance to the objects from the computed disparity.

2. The image processing method for estimating the distance to objects from a plurality of parallax images according to claim 1,
wherein said plurality of parallax images are those captured by image capturing means.

3. An image processing apparatus for estimating the distance to objects from a plurality of parallax images, comprising:
a cost volume preparing portion for preparing a sub-pixel disparity cost volume which contains initial cost values of dissimilarity calculated between the pixel values on a standard image of said plurality of parallax images and the interpolated sub-pixel values on the counterpart image or images other than said standard image in a three-dimensional structure composed of horizontal, vertical and disparity axes,
a filtering portion for eliminating noise signals on the initial cost values in the sub-pixel disparity cost volume while preserving edges or boundaries of objects by using an edge-preserving filter which allocates bigger weights between two cost values whose pixel coordinates have similar pixel values on the standard image,
a disparity selecting portion for selecting a sub-pixel disparity which gives the minimum cost value in the specific disparity range around a previously-given initial pixel-wise or sub-pixel disparity at each pixel coordinate on the standard image, and
a distance estimating portion for estimating the distance to the objects from the computed disparity.

4. An image processing apparatus for estimating the distance to objects from a plurality of parallax images,
wherein said device further comprises a plurality of image capturing means for capturing a plurality of parallax images of the objects,
said plurality of parallax images are captured by said image capturing means.
